(19) United States
(12) Patent Application Publication
(10) Pub. No.: US 2024/0197102 A1
(43) Pub. Date: Jun. 20, 2024

(54) WIDE PRESSURE COOKER

(71) Applicant: Instant Brands Holdings Inc., Downers Grove, IL (US)

(72) Inventors: Jason LePinske, Schaumburg, IL (US); Helen He, Ontario (CA)

(73) Assignee: Instant Brands Holdings Inc., Downers Grove, IL (US)

(21) Appl. No.: 18/529,896

(22) Filed: Dec. 5, 2023

Related U.S. Application Data
(60) Provisional application No. 63/387,437, filed on Dec. 14, 2022.

(51) Int. Cl. A47J 27/08; A47J 27/00; A47J 27/02

(52) U.S. Cl. CPC A47J 27/0802; A47J 27/004; A47J 27/02

(57) ABSTRACT

An apparatus configured to perform pressure cooking includes a housing comprising a rim; a lid coupled to the housing, the lid configured to engage the rim to form an air-tight seal that enables pressure cooking within the housing; and a cooking vessel defining a chamber in which food to be cooked is disposed. A maximum inner diameter of the cooking vessel is at least 1.5 times greater than a maximum vessel depth of the cooking vessel. In addition, or alternatively, at least a portion of a power circuit that controls a heating element, and/or at least a portion of a power circuit housing that houses the power circuit, is higher than a bottom of the cooking vessel.

### RELATED APPLICATION

This application claims the benefit of U.S. Provisional Application No. 63/387,437, filed on Dec. 14, 2022, pending, the entirety of which is incorporated by reference herein.

### TECHNICAL FIELD

The present description relates generally to cooking products, and more specifically to a pressure cooker that has a large cooking surface, a low lift-over height, and/or a low vessel removal height.

### BACKGROUND

Pressure cookers are generally tall structures, in that they are taller than they are wide. Such pressure cookers are too high and narrow such that using a pressure cooker also as an appliance to cook food with the lid open, such as to sauté food, is prohibitive. Also, pressure cookers are typically too narrow to cook large food items, such as a whole chicken or a rack of ribs. However, as desire for a single cooking appliance to allow for multiple types of cooking continually increases, ways to increase the different types of cooking or the numbers of different cooking modes provided by a pressure cooker may be desirable.

### BRIEF SUMMARY

The present description describes a pressure cooking apparatus that includes: a housing comprising a rim; a lid coupled to the housing, the lid configured to engage the rim to form an air-tight seal that enables pressure cooking within the housing; a cooking vessel defining a chamber in which food to be cooked by the pressure cooking apparatus is disposed, wherein a maximum inner diameter of the cooking vessel is at least 1.5 times greater than a maximum vessel depth of the cooking vessel.

The present description also describes a pressure cooking apparatus comprising: a housing comprising a rim; a lid coupled to the housing, the lid configured to engage the rim to form an air-tight seal that enables pressure cooking within the housing; a cooking vessel defining a chamber in which food to be cooked by the pressure cooking apparatus is disposed; a heating element disposed below the cooking vessel; and a power circuit housing that houses a power circuit configured to control the heating element, wherein at least a portion of the power circuit housing is higher than a bottom of the cooking vessel.

Other embodiments are possible, and each of the embodiments can be used alone or together in combination. Accordingly, various embodiments will now be described with reference to the attached drawings.

### BRIEF DESCRIPTION OF THE DRAWINGS

FIG. 1 shows a perspective view of a pressure cooker.

FIG. 2 shows a perspective view of the pressure cooker of FIG. 1 without a lid.

FIG. 3 shows a side perspective view of a cooking vessel of the pressure cooker of FIG. 1.

FIG. 4 shows a perspective view of the pressure cooker of FIG. 1 without the lid and with the cooking vessel removed.

FIG. 5 shows a perspective side view of the pressure cooker of FIG. 1 without an outer casing of the housing to expose a power circuit and power circuit housing.

FIG. 6 shows cross-sectional side view of the pressure cooker of FIG. 1.

### DETAILED DESCRIPTION

The present description describes various embodiments of a product, appliance, apparatus, cooking product, cooking appliance, cooking apparatus, and related methods that provide a wide cooking surface and/or low lift-over height in combination with components that allow for pressure cooking.

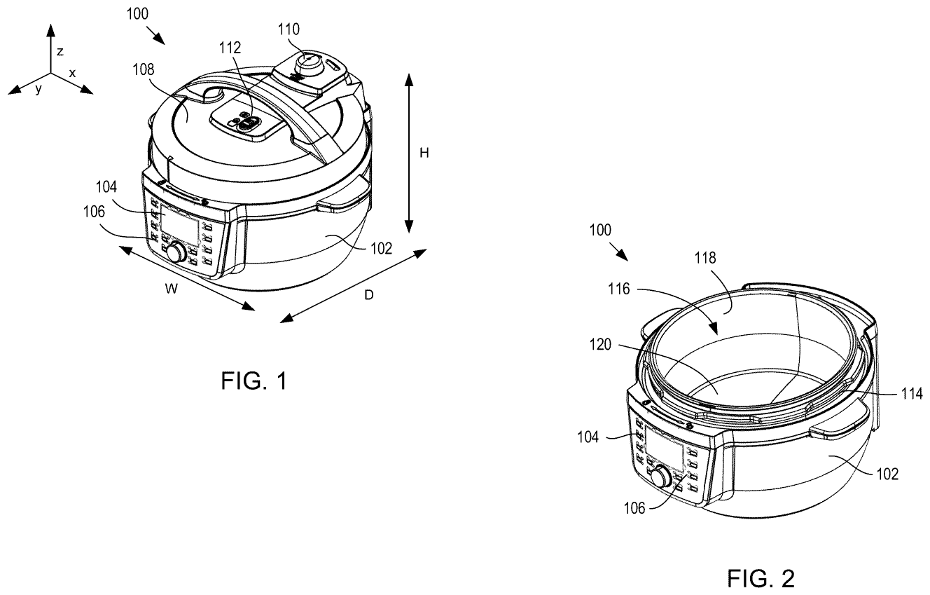

FIG. 1, shows a perspective view of an apparatus 100 configured to pressure cook food (also referred to as a pressure cooker). In general, pressure cooking is a type of cooking that uses steam to raise the boiling point of water above 100 degrees Celsius (212 degrees Fahrenheit). The high temperature may allow food to be cooked faster than when the boiling point is 100 degrees. Pressure cooking may include three stages, including a pre-heating stage, a cooking stage, and a depressurization stage. During the pre-heating stage, liquid water is vaporized into steam. During the cooking stage, the pressure cooker 100 has reached a desired or predetermined pressure level, and cooking begins. The pressure cooker 100 may maintain the pressure at the predetermined pressure level throughout cooking. During the depressurization stage, the pressure cooker 100 vents to reduce the pressure and in turn the temperature to safe levels.

The pressure cooker 100 includes a housing 102 in which food is disposed and cooked. In addition, the pressure cooker 100 may include a control panel 104 integrated with or otherwise coupled to the housing 102. The control panel 104 may include an interface 106 that allows for user inputs to control the operation of the pressure cooker 100. For example, the interface 106 may include buttons, a dial, and/or other similar features configured to receive user inputs that: power on and power off the pressure cooker 100; set a cooking mode, including a pressure cooking mode and/or one or more other cooking modes, such as steam, sauté, slow cook, or bake, as non-limiting examples; set a pressure level (e.g., none, low or high), set an internal cooking temperature (e.g., a particular value or temperature mode such as high and low); preset cooking options; a cooking time; a delay start; an input to keep the pressure cooking warm; and/or a cooking cancel/standby input, as non-limiting examples. The interface 106 may also include a display that displays cooking status information, such as a power status (e.g., on or off) of the pressure cooker 100, a pre-heating status, a temperature, a remaining cooking time, and/or whether a delay start feature is active or inactive, as non-limiting examples. Although not shown in FIG. 1, the control panel 104 may include circuitry internally within the housing, such as behind the interface, that is electrically in communication with interface 106, that can receive and process signal generated in response to user inputs on the interface 106 to effect the inputs (e.g., power on or off the pressure cooker, set an input pressure setting, configure the pressure cooking in an input cooking mode, etc.), and control the display of the interface 106 to display the cooking status information.

The pressure cooker 100 may also include a lid 108 movably coupled to the housing 102. The lid 108 is movable between a closed position and an open position. FIG. 1 shows the lid 108 in the closed position. In general, the lid 108 is configured to enable pressure cooking (e.g., build up steam and/or pressurize) within the pressure cooker 100. For example, in the closed position, the lid 108 is engaged with the housing 102, and the engagement forms an air-tight seal for an internal chamber (not shown in FIG. 1) of the pressure cooker 100 to facilitate pressure cooking. The lid 108 may include one or more of any of various venting mechanisms to release pressure (or depressurize) within the pressure cooker 100, such as a release valve 110 and/or a quick release switch 112. Other venting mechanisms may be possible, such as a floating valve for example. In some embodiments, the lid 108 may also be adapted for air frying, such as by including a fan. In other embodiments, the lid 108 is removable from the housing, and a second lid adapted or configured for a type of cooking different from pressure cooking, such as air frying for example, may be removably connected to the housing 102 for the other, different type of cooking (e.g., air frying).

FIG. 2 shows a perspective view of the pressure cooker 100 without the lid 108. As shown in FIG. 2, the housing 102 may include a rim 114 that is the component of the housing 102 that engages with the lid 108 to form the air-tight seal. The lid 108 and/or the rim 114 may include any of various components to enable the formation of the air-tight seal suitable for pressure cooking, such as sealing ring and/or a sealing ring stack, as non-limiting examples. In addition, as mentioned, the housing 102 may house an inner chamber 116 within which food to be cooked by the pressure cooker 100 may be disposed.

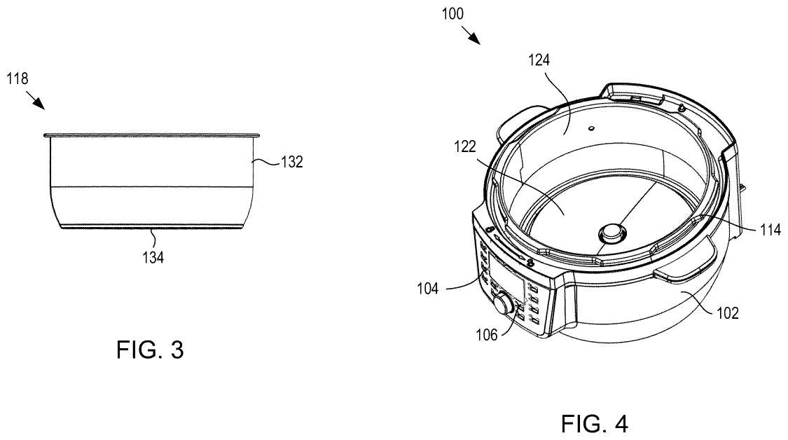

In addition, the pressure cooker 100 may include a cooking vessel (also called a pot, an inner pot, a container, or an inner container) 118 that defines, at least in part, the inner chamber. Food may be disposed on a bottom inner surface 120 of the cooking vessel 118 when the food is in the inner chamber 116. For at least some embodiments, the cooking vessel 118 may be removably coupled to the housing 118. FIG. 3 shows a perspective view of the cooking vessel 118 in isolation. FIG. 4 shows a perspective view of the pressure cooker 100 without the lid 108, and with the cooking vessel 118 removed. In other embodiments, the cooking vessel 118 may be fixedly coupled to the housing 102. Also, the pressure cooker 100 may include a heating element 122 disposed below or under the cooking vessel 118. The heating element 122 may be configured to heat and/or raise a temperature of the inner chamber 116 in order to cook, such as pressure cook, food in the cooking vessel 118. Also, in at least some embodiments, the heating element 122 may be positioned in, integrated with, or a part of an inner container 124 of the housing 102 in which the cooking vessel 118 may be disposed. For embodiments where the cooking vessel 118 is removable, the cooking vessel 118 may be positioned in and removed from the inner container 124.

Also, as used herein, terms “above”, “below”, “top”, “bottom”, “under” and “over”, “beneath”, “upper”, “lower”, “upward”, “downward”, and other similar terms are used to describe components and relative positioning of the components of the pressure cooker 100 and its components when the pressure cooker 100 is positioned in its intended position for operation on a base having a flat surface, such as a countertop or a tabletop, as non-limiting examples. The term “top” is used to refer to the component or components of the pressure cooker 100 that are farthest from the flat surface of the base, and the term “bottom” is used to refer to the component or components of the pressure cooker 100 that are closest to and/or in contact with the flat surface of the base when the pressure cooker 100 is in its intended position. Correspondingly, terms like “above”, “over”, “upper” are used to refer to positioning or disposition of components closer to the “top” and farther from the “bottom” (or farther from the flat surface of the base), and terms like “below”, “under”, and “lower” are used to refer to positioning or disposition of components closer to the “bottom” and farther from the “top” (or closer to the flat surface of the base).

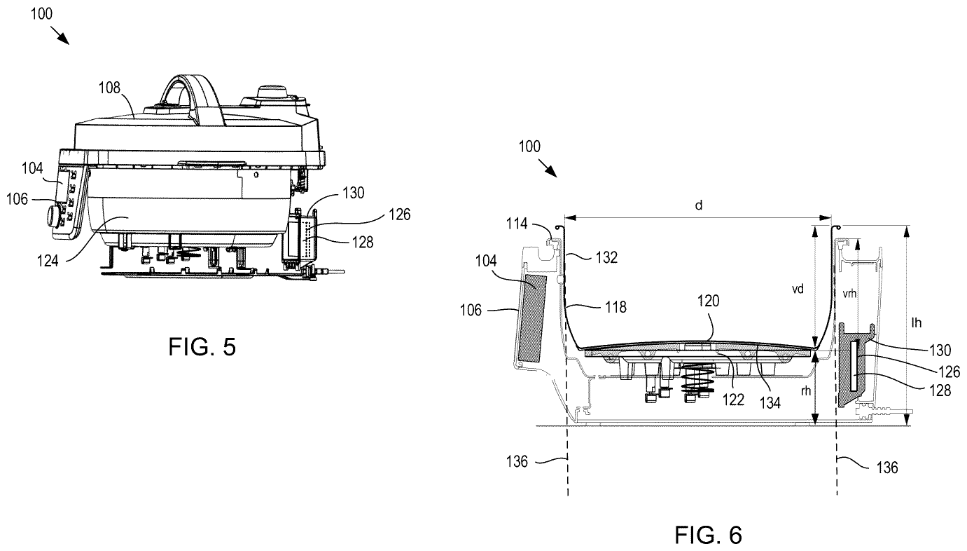

FIG. 5 shows a perspective side view of the pressure cooker 100 without an outer shell or casing of the housing 102 being shown. The pressure cooker 100 may include a power circuit 126 disposed within the housing 102 or otherwise internal to the pressure cooker 100. The power circuit 126 is configured to control, such as through switching, the heating of the heating element 122. The power circuit 126 may include a power printed circuit board (PCB) 128 that is electrically coupled to and configured to control the heating element 122. Although not shown in FIG. 5, the power circuit 126 may include any of various electronic components mounted on or otherwise coupled to the power PCB 128, such as an integrated circuit (IC), resistors, capacitors, inductors, diodes, fuses, and/or varistors as non-limiting examples. The power circuit 126 may handle high power/current/voltage control, whereas the circuitry of the control panel 104 may handle low power control. Additionally, as shown in FIG. 5, the power circuit 126, including the power PCB 128, may be housed with a power circuit housing 130.

Referring back to FIG. 1, when the pressure cooker 100 is disposed in an intended operation position, such as on a flat surface of a base as previously described, the pressure cooker 100 and its components may have certain dimensions as measured relative to the intended operation position and an x-y-z (Cartesian) coordinate system. As used herein, the z-axis direction perpendicular to the base flat surface, and the x-axis and the y-axis extend perpendicular to each other and to the z-axis, and extend parallel with the base flat surface. In addition, as used herein, the z-direction is a direction that extends along and/or parallel with the z-axis, the x-direction is a direction that extends along and/or parallel with the x-axis, and the y-direction is a direction that extends along and/or parallel with the y-axis. As indicated in FIG. 1, the pressure cooker 100 may have a width W extending in the x-direction, a depth D extending in the y-direction, and a height H extending in the z-direction. Other dimensions of the pressure cooker 100 relative to the x-y-z coordinate system may be determined. For example, a diameter of the pressure cooker 100 or one of its components may be a dimension in a plane extending in the x and y-directions.

Referring to FIG. 3, the cooking vessel 118 may have dimensions relative to the x-y-z coordinate system shown in FIG. 1. For example, the cooking vessel 118 may have a maximum inner diameter d and a maximum vessel depth vd. The maximum inner diameter d may be measured in an x-y plane between inner surface portions of a side wall 132 of the cooking vessel 118. The maximum vessel depth vd may be measured in the z-direction from the top of the cooking vessel 118 to a location of the inner surface 120 of a bottom 134 of the cooking vessel 118 that provides the greatest distance. The cooking vessel 118 may also have a vessel height, which may be measured from the top of the cooking vessel 118 to the bottom 134 of the cooking vessel. In general, the vessel height is substantially the same as the vessel depth, plus the thickness of the bottom 134 of the cooking vessel 118.

In the embodiments of the pressure cooker 100 described herein, the cooking vessel 118 may have a maximum inner diameter d that is at least 1.5 times greater than the maximum vessel depth vd. In particular of these embodiments, the maximum inner diameter d is at least 2 times greater than the maximum vessel depth vd. In some of these embodiments, the maximum inner diameter d is at least 2.2 times greater than the maximum vessel depth vd. In addition or alternatively, in some embodiments, the maximum inner diameter d is at least 250 millimeters (mm). In particular of these embodiments, the maximum inner diameter d is in a range between 260 mm and 300 mm. In other of these embodiments, the maximum inner diameter d is in a range between 270 mm and 290 mm. In other of these embodiments, the maximum inner diameter d is 280 mm. In addition or alternatively, in some embodiments, the maximum vessel depth vd is at most 150 mm. In particular of these embodiments, the maximum vessel depth vd is in a range between 120 mm and 140 mm. In other of these embodiments, the maximum vessel depth vd is in a range between 125 mm and 135 mm. In other of these embodiments, the maximum vessel depth vd is 128 mm.

For other known or traditional pressure cookers, the maximum inner diameter d may be smaller than the vessel depth. By having the maximum inner diameter d at least 1.5 times greater than the maximum vessel depth vd and/or at least 250 mm, the pressure cooker 100 may have a larger bottom inner surface 120 for cooking compared to these other pressure cookers. Such a larger bottom inner surface 120 may be more optimal or desirable for cooking with the lid 108 in an open position, such as sautéing vegetables, and/or for cooking (e.g., browning) larger pieces of food, such as a roast, a whole chicken, a rack of ribs, or a whole piece of salmon, as non-limiting examples.

Additionally, in at least some embodiments, the pressure cooker 100 may have a minimized lift-over height lh, or at least a lift-over height lh that is lower compared to known or traditional pressure cookers. In general, the lift-over height lh is a minimum distance in the z-direction from the base surface (countertop, table surface, etc.) over which the user traverses in order to gain access to within the inner chamber 116, such as with a cooking utensil and/or for purposes of placing food within the inner chamber 116 or on the bottom surface 120 of the cooking vessel 118. Accordingly, the lower the lift-over height lh, the easier it may be for a user to access and/or cook (e.g., sauté) food disposed on the bottom surface 120 of the cooking vessel 118. As previously described, the pressure cooker 100 provides a larger bottom surface 120 compared to other pressure cookers, which in turn provides a better surface for cooking (e.g., sautéing) food on the bottom surface 120 with the lid 108 open. A minimized or lower lift-over height enhances this functionality by making it easier for the user to perform such cooking. In at least some embodiments of the pressure cooker 100, the lift-over height lh is at most 300 mm. In particular of these embodiments, the lift-over height lh is less than 250 mm. In other of these embodiments, the lift-over height lh is less than 225 mm. In other of these embodiments, the lift-over height lh is 210 mm.

As indicated in FIG. 6, the lift-over height lh may be based on a resting height rh of the pressure cooker 100. The resting height rh is the smallest distance in the z-direction that the cooking vessel 118 is above the base surface when disposed in the pressure cooker 100, as measured from the base surface to the lowest part of the bottom 134 of the cooking vessel 118. In some embodiments, the resting height rh is at most 120 mm. In particular of these embodiments, the resting height rh is in a range of between 70 mm and 100 mm.

In addition, as shown in FIGS. 5 and 6, the power circuit 126, including the power PCB 128, and the power circuit housing 130, may be disposed at a location that is not below or under the bottom 134 of the cooking vessel 118 and/or the heating element 122. Positioning the power circuit 126 including the power PCB 128 and the power circuit housing 130 away from the area below the bottom 134 of the cooking vessel 118 may, in turn, allow for a minimized or reduced resting height rh, and in turn, a minimized or reduced lift-over height lh. In addition, moving the power circuit 126 away from the area below the bottom 134 of the cooking vessel 118 may desirably remove the power circuit 124 away from the path of liquid in event that liquid or food reaches the heating element 122 or the area below the heating element 122, such as if a user improperly or accidentally placed, poured, or spilled food or liquid into the inner chamber 116 of the pressure chamber 100 without the cooking vessel in the pressure chamber 100.

In some embodiments, such as shown in FIGS. 5 and 6, the power circuit 126 including the power PCB and/or the power circuit housing 130 may be disposed outside of a width-depth profile of the cooking vessel 118. In general, as used herein, a width-depth profile of a component is a profile of the component defined by lines extending in the height or z-direction that intersect a certain contour of the component extending in a width-depth or x-y plane. With respect to the cooking vessel 118, the width-depth profile may be defined by lines, including dotted lines 136, extending in the height or z-direction that intersect the side wall 132, such that the width-depth profile of the cooking vessel 118 is generally cylindrical with a diameter substantially the same as the maximum inner diameter d of the cooking vessel 118. In addition or alternatively, at least a portion of the power circuit housing 130, such as a top portion, may be higher (or farther away from the bottom of the pressure cooker 100) than the bottom 134 of the cooking vessel 118.

In addition, as shown in FIGS. 5 and 6, the power circuit 126 including the power PCB 128, and/or the power circuit housing 130, may be circumferentially disposed at least 90 degrees from the control panel 104. In particular embodiments, such as shown in FIGS. 5 and 6, the power circuit 126 including the power PCB 128, and/or the power circuit housing 130, may be circumferentially disposed substantially 180 degrees from the control interface 104. For at least some embodiments, the portion of the pressure cooker 100 that is circumferentially 180 degrees from the control panel 104 may be considered the “rear” of the pressure cooker 100. Positioning the power circuit 126 circumferentially at least 90 degrees from the control panel 104 desirably physically isolates the high-energy components of the power circuit 126 from the circuitry of the control panel 104, which operates on low voltage. The physical isolation reduces the chance of a user receiving a shock from the pressure cooker 100 when contacting the control panel 104 with wet hands in event that the control panel 104 is splashed with liquid.

Another dimension of the pressure cooker 100 is vessel removal height vrh, which is a minimum height in the z-direction that a user must move or lift the cooking vessel 118 from its resting position in the pressure cooker 100 in order to remove or separate the cooking vessel 118 from the rest of the pressure cooker 100. The vessel removal height vrh may be determined from the bottom 134 of the cooking vessel 118 to a top part of the rim 114. The lower the vessel removal height vrh, the easier it is for a user to remove the cooking vessel 118 from the rest of the pressure cooker 100. In some embodiments, the vessel removal height vrh is at most 150 mm. In particular of these embodiments, the vessel removal height vrh is in a range of 125 to 140 mm. In other of these embodiments, the vessel removal height vrh is 118 mm.

The subject matter of the present description may also relate, among others, to the following aspects:

A first aspect includes a pressure cooking apparatus that includes: a housing comprising a rim; a lid coupled to the housing, the lid configured to engage the rim to form an air-tight seal that enables pressure cooking within the housing; a cooking vessel defining a chamber in which food to be cooked by the pressure cooking apparatus is disposed, wherein a maximum inner diameter of the cooking vessel is at least 1.5 times greater than a maximum vessel depth of the cooking vessel.

A second aspect includes the first aspect, and further includes wherein the maximum inner diameter of the cooking vessel is at least 2 times greater than the maximum vessel depth of the cooking vessel.

A third aspect includes the second aspect, and further includes wherein the maximum inner diameter of the cooking vessel is at least 2.2 times greater than the maximum vessel depth of the cooking vessel.

A fourth aspect includes any of the first through third aspects, and further includes: a heating element disposed below the cooking vessel; and a power printed circuit board (PCB) configured to control the heating element, the power PCB disposed within the housing not below a bottom of the cooking vessel.

A fifth aspect includes the fourth aspect, and further includes wherein the power PCB is disposed outside of a width-depth profile of the cooking vessel.

A sixth aspect includes any of the fourth or fifth aspects, and further includes a control interface coupled to the housing, wherein the power PCB is circumferentially positioned about the cooking vessel at least 90 degrees from the control interface.

A seventh aspect includes the sixth aspect, and further includes wherein the power PCB is circumferentially disposed about 180 degrees from the control interface.

An eighth aspect includes any of the first through seventh aspects, and further includes wherein the maximum inner diameter is at least 250 millimeters.

A ninth aspect includes any of the first through eighth aspects, and further includes wherein the maximum vessel depth is at most 150 millimeters.

A tenth aspect includes any of the first through ninth aspects, and further includes wherein a lift-over height of the pressure cooking apparatus is less than 250 millimeters.

An eleventh aspect includes any of the first through tenth aspects, and further includes wherein a vessel removal height of the pressure cooking apparatus is less than 150 millimeters.

A twelfth aspect includes a pressure cooking apparatus comprising: a housing comprising a rim; a lid coupled to the housing, the lid configured to engage the rim to form an air-tight seal that enables pressure cooking within the housing; a cooking vessel defining a chamber in which food to be cooked by the pressure cooking apparatus is disposed; a heating element disposed below the cooking vessel; and a power circuit housing that houses a power circuit configured to control the heating element, wherein at least a portion of the power circuit housing is higher than a bottom of the cooking vessel.

A thirteenth aspect includes the twelfth aspect and further includes wherein the maximum inner diameter of the cooking vessel is at least 2 times greater than the maximum vessel depth of the cooking vessel.

A fourteenth aspect includes the thirteenth aspect, and further includes wherein the maximum inner diameter of the cooking vessel is at least 2.2 times greater than the maximum vessel depth of the cooking vessel.

A fifteenth aspect includes any of the twelfth through fourteenth aspects, and further includes a control interface coupled to the housing, wherein the power PCB is circumferentially positioned about the cooking vessel at least 90 degrees from the control interface.

A sixteenth aspect includes the fifteenth aspect, and further includes wherein the power PCB is circumferentially disposed about 180 degrees from the control interface.

A seventeenth aspect includes any of the twelfth through sixteenth aspects, and further includes wherein the maximum inner diameter is at least 250 millimeters.

An eighteenth aspect includes any of the twelfth through seventeenth aspects, and further includes wherein the maximum vessel depth is at most 150 millimeters.

A nineteenth aspect includes any of the twelfth through eighteenth aspects, and further includes wherein a lift-over height of the pressure cooking apparatus is less than 250 millimeters.

A twentieth aspect includes any of the twelfth through nineteenth aspects, and further includes wherein a vessel removal height of the pressure cooking apparatus is less than 150 millimeters.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A pressure cooking apparatus comprising:
a housing comprising a rim;
a lid coupled to the housing, the lid configured to engage the rim to form an air-tight seal that enables pressure cooking within the housing;
a cooking vessel defining a chamber in which food to be cooked by the pressure cooking apparatus is disposed,
wherein a maximum inner diameter of the cooking vessel is at least 1.5 times greater than a maximum vessel depth of the cooking vessel.

2. The cooking apparatus of claim 1, wherein the maximum inner diameter of the cooking vessel is at least 2 times greater than the maximum vessel depth of the cooking vessel.

3. The cooking apparatus of claim 2, wherein the maximum inner diameter of the cooking vessel is at least 2.2 times greater than the maximum vessel depth of the cooking vessel.

4. The cooking apparatus of claim 1, further comprising:
a heating element disposed below the cooking vessel; and
a power printed circuit board (PCB) configured to control the heating element, the power PCB disposed within the housing not below a bottom of the cooking vessel.

5. The cooking apparatus of claim 4, wherein the power PCB is disposed outside of a width-depth profile of the cooking vessel.

6. The cooking apparatus of claim 4, further comprising a control interface coupled to the housing, wherein the power PCB is circumferentially positioned about the cooking vessel at least 90 degrees from the control interface.

7. The cooking apparatus of claim 6, wherein the power PCB is circumferentially disposed about 180 degrees from the control interface.

8. The cooking apparatus of claim 1, wherein the maximum inner diameter is at least 250 millimeters.

9. The cooking apparatus of claim 1, wherein the maximum vessel depth is at most 150 millimeters.

10. The cooking apparatus of claim 1, wherein a lift-over height of the pressure cooking apparatus is less than 250 millimeters.

11. The cooking apparatus of claim 1, wherein a vessel removal height of the pressure cooking apparatus is less than 150 millimeters.

12. A pressure cooking apparatus comprising:
a housing comprising a rim;
a lid coupled to the housing, the lid configured to engage the rim to form an air-tight seal that enables pressure cooking within the housing;
a cooking vessel defining a chamber in which food to be cooked by the pressure cooking apparatus is disposed;
a heating element disposed below the cooking vessel; and
a power circuit housing that houses a power circuit configured to control the heating element, wherein at least a portion of the power circuit housing is higher than a bottom of the cooking vessel.

13. The cooking apparatus of claim 12, wherein the maximum inner diameter of the cooking vessel is at least 2 times greater than the maximum vessel depth of the cooking vessel.

14. The cooking apparatus of claim 13, wherein the maximum inner diameter of the cooking vessel is at least 2.2 times greater than the maximum vessel depth of the cooking vessel.

15. The cooking apparatus of claim 12, further comprising a control interface coupled to the housing, wherein the power PCB is circumferentially positioned about the cooking vessel at least 90 degrees from the control interface.

16. The cooking apparatus of claim 15, wherein the power PCB is circumferentially disposed about 180 degrees from the control interface.

17. The cooking apparatus of claim 12, wherein the maximum inner diameter is at least 250 millimeters.

18. The cooking apparatus of claim 12, wherein the maximum vessel depth is at most 150 millimeters.

19. The cooking apparatus of claim 12, wherein a lift-over height of the pressure cooking apparatus is less than 250 millimeters.

20. The cooking apparatus of claim 12, wherein a vessel removal height of the pressure cooking apparatus is less than 150 millimeters.
